(19) United States
(12) Patent Application Publication
(10) Pub. No.: US 2006/0067752 A1
(43) Pub. Date: Mar. 30, 2006

(54) Belt fuser assembly with heated backup roll in an electrophotographic imaging device

(76) Inventors: Jichang Cao, Lexington, KY (US); James D. Gilmore, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/955,536

(22) Filed: Sep. 29, 2004

(51) Int. Cl. G03G 15/20

(52) U.S. Cl. 399/329

(57) ABSTRACT

An electrophotographic imaging device includes a print media transport assembly, and a fuser positioned in association with the print media transport assembly. The fuser includes a first heater assembly; a belt positioned around and adjacent to the first heater assembly; a backup roll positioned in opposition to the first heater assembly on a side of the belt opposite the first heater assembly, the belt and the backup roll defining a fusing nip therebetween; and a second heater assembly positioned in association with the backup roll.

### BACKGROUND OF THE INVENTION

1. Field of the Invention

The present invention relates generally to electrophotographic imaging devices and, more particularly, to fusers of electrophotographic imaging devices.

2. Description of the Related Art

In the electrophotographic (EP) imaging process used in printers, copiers and the like, a photosensitive member, such as a photoconductive drum or belt, is uniformly charged over an outer surface. An electrostatic latent image is formed by selectively exposing the uniformly charged surface of the photosensitive member. Toner particles are applied to the electrostatic latent image, and thereafter the toner image is transferred to the media intended to receive the final permanent image. The toner image is fixed to the media by the application of heat and pressure in a fuser. A fuser may include a heated roll and a backup roll forming a fuser nip through which the media passes. A fuser may also include a fuser belt and an opposing backup member, such as a backup roll.

In color EP imaging, time to first print from cold start is an important factor. If the time to first print is short enough, the printer need not use standby mode, and therefore significantly reduces power usage. The environmental impact of reducing power usage has led to the “Energy Star Program” developed by the “Sustainable Energy Development Authority” (SEDA). SEDA is a New South Wales Government agency that runs in conjunction with the USA Environmental Protection Agency (EPA). These governmental agencies promote the reduction in power usage by setting the Energy Star rating for low power.

Energy Star specifications and a desire for fast first copy times require that fusers be ready for printing from room temperature in seconds, not minutes. Conventional roller fusers are unable to meet this requirement due to large thermal masses. A belt fuser using ceramic or inductive heating heats up very quickly and can be ready for printing within 20 seconds. Normally such belt fusers are used in mid-range mono or low-speed color applications. Either the belt temperature cannot be kept high enough to achieve good fusing quality for high speed printing or the printing speed has to slow down to prevent portions of the belt from overheating.

FIG. 1 is a graphical illustration of a temperature response curve for a conventional printer having a belt fuser and ceramic heater positioned within the belt. FIG. 2 is a graphical illustration of a temperature response curve for a conventional printer having a belt fuser and an inductive heater positioned within the belt. During printing of 32# Hammermill paper at 32 PPM, the belt surface temperature for ceramic heaters cannot be kept higher than 160° C. As print speed increases and more heat is transferred to the media, belt surface temperatures are maintained at even lower levels. During printing, the belt temperature outside of the paper path can exceed the maximum temperature limit of the belt, 200° C., within a very short time. To prevent belt overheating from occurring, the printer with belt fuser and inductive heater shown in FIG. 2 pauses or slows during printing to allow the belt to cool down. After detecting the belt temperature is above 200° C., the printer slows down throughput from full speed to only 4 PPM.

The empirical test results illustrated in FIGS. 1 and 2 show that a belt fuser with a ceramic heater or an inductive heater has very small thermal extendibility, especially for a fuser using a metal belt coated with silicone rubber on its surface. This small thermal extendibility makes it very difficult for a belt fuser to meet all fusing requirements for high-speed printers.

In current belt fusers, when a print job is initiated and the backup roller is cool, the operating temperature is elevated over the normal steady state temperature by as much as 50° C. The excessively high temperatures required for fusing with a cool/cold backup roller can cause the belt to heat to such a temperature that material failure will occur prematurely and the belt will not meet fuser life requirements. For belts coated with silicone rubber, the primer layer between the base layer and the silicone rubber layer is one typical weak point. Another point of possible failure is between the PFA sleeve and the base/silicone rubber layer, if such a sleeve is used in the belt construction. For polyimide belts, material failure occurs in the form of belt buckling or tearing at the edges.

What is needed in the art is a belt fuser which has an increased thermal extendibility with improved print quality.

### SUMMARY OF THE INVENTION

To increase belt fuser thermal capability, the present invention provides a belt fuser with a heated backup roll. Using a heated backup roller allows heat to be conducted to media from both sides; reducing fusing temperature requirements of the belt. As the backup roller is maintained at a higher temperature than a non-heated backup roller, belt temperatures for jobs from cool starting conditions need not be excessively high. The fuser belt may be heated with a ceramic or inductive heater, and the backup roll may be heated with a lamp or inductive heater.

The invention comprises, in one form thereof, an electrophotographic imaging device, including a print media transport assembly, and a fuser positioned in association with the print media transport assembly. The fuser includes a first heater assembly; a belt positioned around and adjacent to the first heater assembly; a backup roll positioned in opposition to the first heater assembly on a side of the belt opposite the first heater assembly, the belt and the backup roll defining a fusing nip therebetween; and a second heater assembly positioned in association with the backup roll.

The invention comprises, in another form thereof, a method of operating a fuser of an electrophotographic imaging device, including the steps of: transporting a print medium to the fuser; carrying the print medium through a fusing nip between a belt and a backup member; and heating toner particles on the print medium using a first heater assembly positioned on a side of the belt opposite the print medium, and a second heater assembly positioned in association with the backup roll.

An advantage of the present invention is that the belt fuser and heated backup roll combination provides a higher thermal extendibility to allow the belt fuser to meet high speed printing requirements.

Another advantage is that the belt fuser with heated backup roll reduces paper curl.

Yet another advantage is that the belt fuser with heated backup roll eliminates belt stalls due to water condensation on the backup roll.

A further advantage is that the belt fuser with heated backup roll allows for higher gloss printing at printing speeds of 32 pages per minute or greater.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a graphical illustration of a temperature response curve of a conventional belt fuser having a ceramic heater;

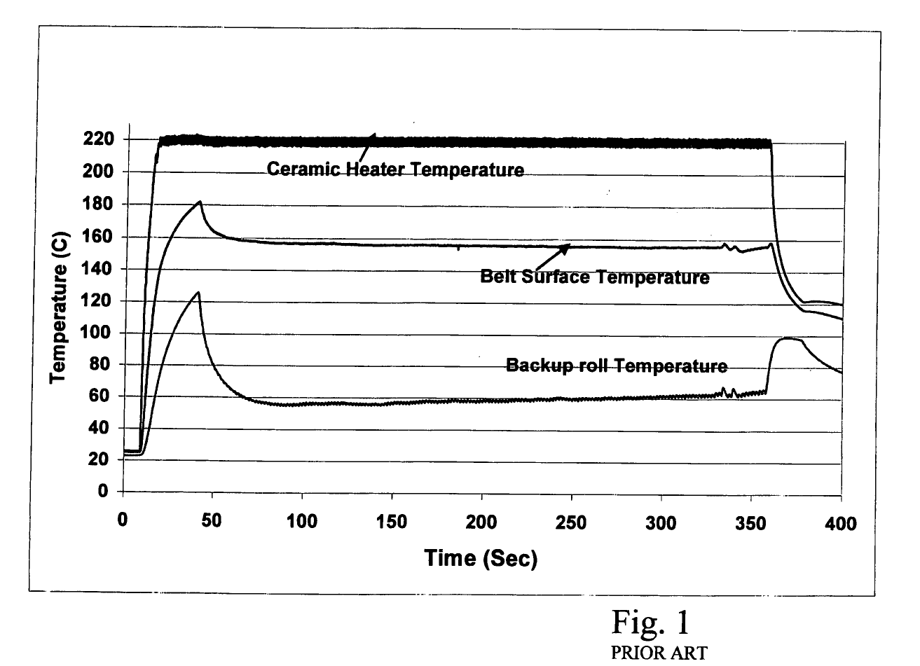

FIG. 2 is a graphical illustration of a temperature response curve of a conventional belt fuser having an inductive heater;

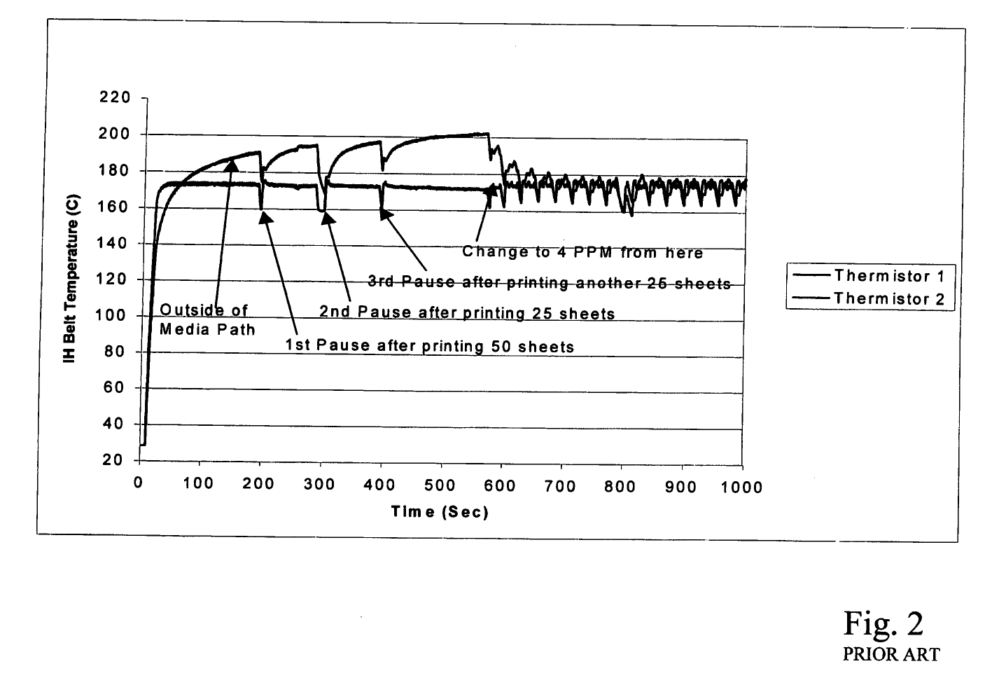

FIG. 3 is a schematic view of an imaging device, in the form of a printer, incorporating a fuser of the present invention;

FIG. 4 is a schematic end view of an embodiment of a fuser of the present invention;

FIG. 5 is a schematic end view of another embodiment of a fuser of the present invention;

FIG. 6 is a schematic end view of yet another embodiment of a fuser of the present invention; and

FIG. 7 is a schematic end view of still another embodiment of a fuser of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

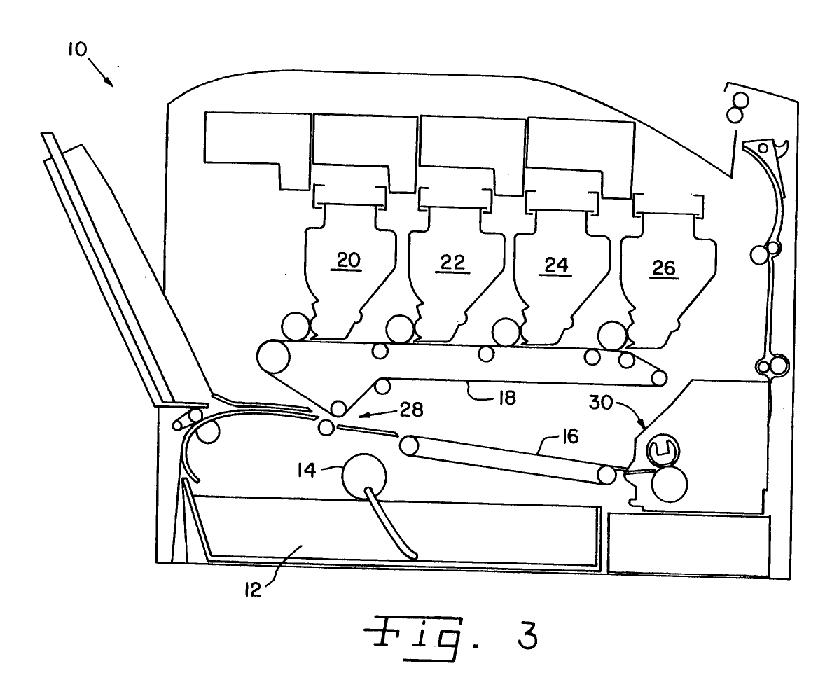

Referring now to the drawings and particularly to FIG. 3, there is shown an embodiment of an EP printer 10 of the present invention. Paper supply tray 12 contains a plurality of print media (not shown), such as paper, transparencies or the like. A print medium transport assembly (not numbered) includes a plurality of rolls and/or transport belts for transporting individual print media through EP printer 10. For example, in the embodiment shown, the print medium transport assembly includes a pick roll 14 and a paper transport belt 16. Pick roll 14 picks an individual print medium from within paper supply tray 12, and the print medium is transported past an intermediate transfer member (ITM) in the form of an ITM belt 18. A plurality of color imaging stations 20, 22, 24 and 26 apply toner particles of a given color to ITM belt 18 at selected pixel locations. The toner particles are then transferred from ITM belt 18 to the print medium in nip 28. In the embodiment shown, color imaging station 20 is a black (K) color imaging station; color imaging station 22 is a magenta (M) color imaging station; color imaging station 24 is a cyan (C) color imaging station; and color imaging station 26 is a yellow (Y) color imaging station.

Paper transport belt 16 transports an individual print medium to fuser 30 where the toner particles are fused to the print medium through the application of heat and pressure. Fuser 30 includes a first heater assembly 32, flexible belt 34 carried by heater assembly 32, backup roll 36, and a second heater assembly 38. In the embodiment shown, backup roll 36 is a driven roll and belt 34 is an idler belt; however, the drive scheme may be reversed depending upon the application. Belt 34 and backup roll 36 define a fusing nip 40 therebetween.

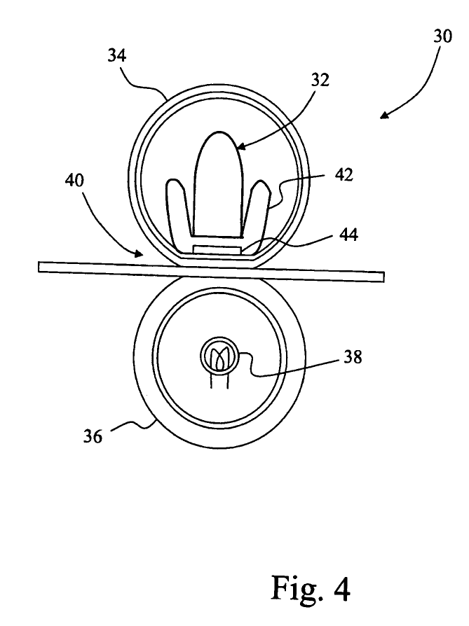

Referring now to FIGS. 4-7, different embodiments of fuser 30 shown in FIG. 3 will be described in greater detail. In general, first heater assembly 32 may be in the form of a ceramic heater or inductive heater, and second heater assembly 38 may be in the form of a lamp heater or inductive heater.

Referring to FIG. 4, first heater assembly 32 is a ceramic heater assembly including a high temperature housing 42 (liquid crystal polymer or the like) carrying a ceramic heater 44. Ceramic heater 44 includes a ceramic substrate (alumina, aluminum nitride, etc.), a resistive ink pattern screened onto the substrate, and one or more glass protective layers. Other types of ceramic heaters may also be used.

Belt 34 includes a polyimide layer, and optionally may include a metal layer and/or a silicone layer. Belt 34 also preferably includes a release layer in the form of a PFA or PTFE coating, or a PFA sleeve (PFA is a perfluoroalkyl vinyl ether copolymer, and PTFE is polytetrafluoroethylene).

Backup roll 36 has a metallic core and an elastomeric covering, but may be differently configured. Techniques for the general concept of rotatably driving backup roll 36 using gears, belts, pulleys and the like (not shown) are conventional and not described in detail herein.

Second heater assembly 38 is a lamp heater in the form of an incandescent lamp. Second heater assembly 38 has a power level of between approximately 400 to 900 watts, and preferably approximately 600 watts.

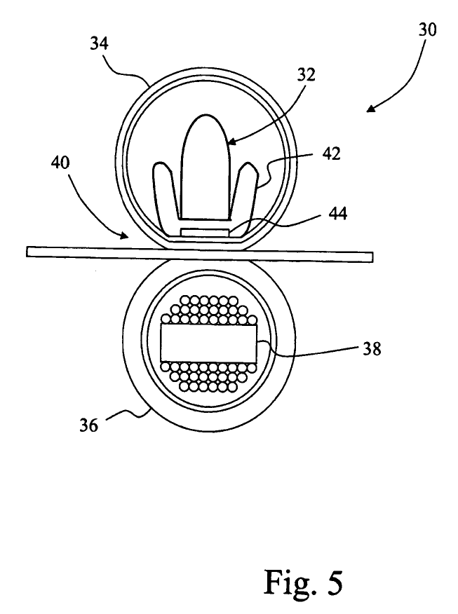

Referring to FIG. 5, first heater assembly 32 and belt 34 are configured similar to the embodiment shown in FIG. 4, with first heater assembly 32 being again configured as a ceramic heater assembly. Likewise, backup roll 36 is configured similar to the embodiment shown in FIG. 4. However, second heater assembly 38 is configured as an inductive heater rather than a lamp heater. When configured as an inductive heater, second heater assembly 38 has a power level of between approximately 400 to 900 watts, and preferably approximately 600 watts.

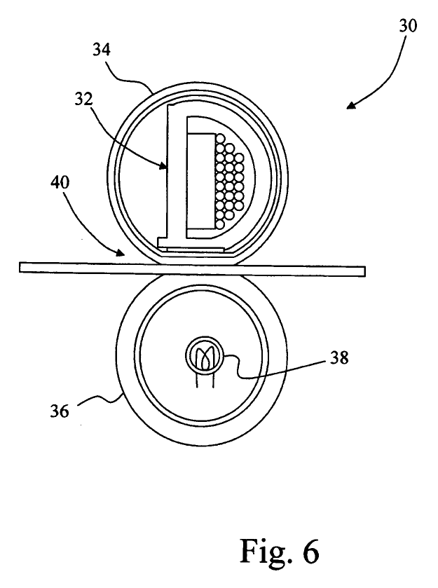

Referring to FIG. 6, first heater assembly 32 is configured as an inductive heater rather than a ceramic heater. When configured as an inductive heater, belt 34 has a metal layer coated with a polyimide layer and/or a silicone rubber layer. Backup roll 36 and second heater assembly 38 in the form of a lamp heater are configured similar to the embodiment shown in FIG. 4.

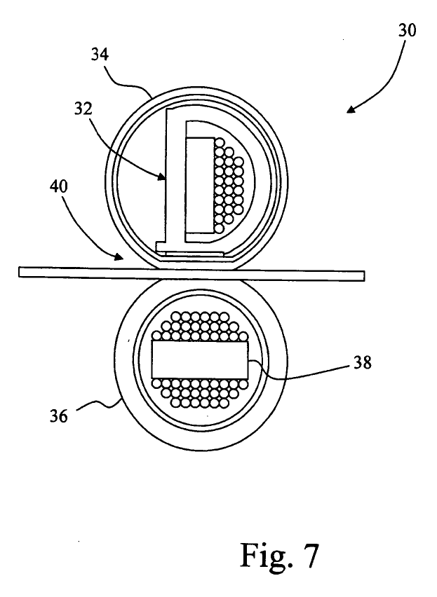

Referring to FIG. 7, first heater assembly 32 is configured as an inductive heater, similar to the embodiment of FIG. 6. Belt 34 thus has a metal layer coated with a polyimide layer and/or a silicone rubber layer. Backup roll 36 and second heater assembly 38 in the form of an inductive heater are configured similar to the embodiment shown in FIG. 5.

During fusing, toner particles are transferred from ITM belt 18 to a print medium. The print medium with toner particles is transferred to fusing nip 40, where heat is applied to one side of the print medium by belt 34 and to the other side of the print medium by backup roll 36. Belt 34 and backup roll 36 are respectively heated by first heater assembly 32 and second heater assembly 38.

Current color belt fusing systems use expensive belts and heating methods, yet still suffer from significant print quality issues. Although time to first print has been reduced dramatically providing quick heating fusing systems, high gloss images cannot be achieved, and significant gloss variation is observed. Also the transmittance on transparencies is poor and could be considered unacceptable. High speeds over 32 ppm have not been achieved in ceramic heated color belt fusing systems. The use of belt fuser 30 with heated backup roll 36 described above provides an instant-on belt fusing system that has increased thermal extendibility.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrophotographic imaging device, comprising:
a print media transport assembly; and
a fuser positioned in association with said print media transport assembly, said fuser including:
a first heater assembly;
a belt positioned around and adjacent to said first heater assembly;
a backup roll positioned in opposition to said first heater assembly on a side of said belt opposite said first heater assembly, said belt and said backup roll defining a fusing nip therebetween; and
a second heater assembly positioned in association with said backup roll.

2. The electrophotographic imaging device of claim 1, wherein said first heater assembly comprises one of an inductive heater and a ceramic heater.

3. The electrophotographic imaging device of claim 1, wherein said first heater assembly comprises a ceramic heater, and said belt includes a polyimide layer.

4. The electrophotographic imaging device of claim 3, wherein said belt includes a silicone rubber layer.

5. The electrophotographic imaging device of claim 4, wherein said belt includes an outer release layer, said release layer including one of a PFA and PTFE material.

6. The electrophotographic imaging device of claim 5, wherein said release layer comprises one of a coating and a sleeve.

7. The electrophotographic imaging device of claim 3, wherein said belt includes an outer release layer, said release layer including one of a PFA and PTFE material.

8. The electrophotographic imaging device of claim 3, wherein said belt includes a metal layer.

9. The electrophotographic imaging device of claim 7, wherein said belt includes a silicone rubber layer.

10. The electrophotographic imaging device of claim 9, wherein said belt includes an outer release layer, said release layer including one of a PFA and PTFE material.

11. The electrophotographic imaging device of claim 10, wherein said release layer comprises one of a coating and a sleeve.

12. The electrophotographic imaging device of claim 1, wherein said first heater assembly comprises an inductive heater, and said belt includes a metal layer.

13. The electrophotographic imaging device of claim 12, wherein said belt includes at least one of a polyimide layer and a silicone layer.

14. The electrophotographic imaging device of claim 13, wherein said belt includes an outer release layer, said release layer including one of a PFA and PTFE material.

15. The electrophotographic imaging device of claim 1, wherein said second heater is positioned within said backup roll.

16. The electrophotographic imaging device of claim 1, wherein said second heater comprises one of an inductive heater and a lamp heater.

17. A fuser for an electrophotographic imaging device, said fuser comprising:
a first heater assembly;
a belt positioned around and adjacent to said first heater assembly;
a backup roll positioned in opposition to said first heater assembly on a side of said belt opposite said first heater assembly, said belt and said backup roll defining a fusing nip therebetween; and
a second heater assembly positioned in association with said backup roll.

18. The fuser of claim 17, wherein said first heater assembly comprises one of an inductive heater and a ceramic heater.

19. The fuser of claim 17, wherein said first heater assembly comprises a ceramic heater, and said belt includes a polyimide layer.

20. The fuser of claim 19, wherein said belt includes a silicone rubber layer.

21. The fuser of claim 20, wherein said belt includes an outer release layer, said release layer including one of a PFA and PTFE material.

22. The fuser of claim 21, wherein said release layer comprises one of a coating and a sleeve.

23. The fuser of claim 19, wherein said belt includes an outer release layer, said release layer including one of a PFA and PTFE material.

24. The fuser of claim 19, wherein said belt includes a metal layer.

25. The fuser of claim 24, wherein said belt includes a silicone rubber layer.

26. The fuser of claim 25, wherein said belt includes an outer release layer, said release layer including one of a PFA and PTFE material.

27. The fuser of claim 26, wherein said release layer comprises one of a coating and a sleeve.

28. The fuser of claim 17, wherein said first heater assembly comprises an inductive heater, and said belt includes a metal layer.

29. The fuser of claim 28, wherein said belt includes at least one of a polyimide layer and a silicone layer.

30. The fuser of claim 29, wherein said belt includes an outer release layer, said release layer including one of a PFA and PTFE material.

31. The fuser of claim 17, wherein said second heater is positioned within said backup roll.

32. The fuser of claim 17, wherein said second heater comprises one of an inductive heater and a lamp heater.

33. A method of operating a fuser of an electrophotographic imaging device, comprising the steps of:
transporting a print medium to said fuser;
carrying the print medium through a fusing nip between a belt and a backup member; and
heating toner particles on the print medium using a first heater assembly positioned on a side of said belt opposite the print medium, and a second heater assembly positioned in association with said backup roll.

34. The method of operating a fuser of claim 33, wherein said first heater assembly comprises one of an inductive heater and a ceramic heater.

35. The method of operating a fuser of claim 33, wherein said second heater comprises one of an inductive heater and a lamp heater.

36. The method of operating a fuser of claim 33, said second heater assembly being positioned within said backup roll.
